(19) United States
(12) Patent Application Publication
(10) Pub. No.: US 2025/0104284 A1
(43) Pub. Date: Mar. 27, 2025

(54) HIGH QUALITY TRANSCODE-EFFICIENT TEXTURE FORMAT

(71) Applicant: Sony Interactive Entertainment LLC, San Mateo, CA (US)

(72) Inventor: Thomas Madams, Seattle, WA (US)

(21) Appl. No.: 18/475,901

(22) Filed: Sep. 27, 2023

(51) Int. Cl. G06T 9/00; A63F 13/35; H04N 19/122; H04N 19/129; H04N 19/186; H04N 19/196

(52) U.S. Cl. CPC G06T 9/00; A63F 13/35; H04N 19/122; H04N 19/129; H04N 19/186; H04N 19/198; A63F 2300/538; G06T 2210/08

(57) ABSTRACT

Techniques are described for transcoding textures which include computing plural endpoint colors for the macroblocks. In a first technique forward Discrete Cosine Transform (DCT) is applied to macroblocks or portions thereof and used to represent the respective portions. In a second technique a mean of the endpoint colors and a difference between the endpoint colors are computed, with the mean and the difference establishing a projection vector in color-space. The mean and the difference are compressed and per-pixel distances along the projection vector are computed and used along with the respective mean and difference to represent the macroblock.

### FIELD

The present application relates to technically inventive, non-routine solutions that are necessarily rooted in computer technology and that produce concrete technical improvements, and more specifically to high quality transcode-efficient texture formats.

### BACKGROUND

In computer simulations such as computer gaming, objects are rendered in part using “texture” data that describes the surfaces of the objects. The more texture data for a given object, the higher resolution the rendering can be. However, for bandwidth purposes it is desirable not to send large texture data structures to a rendering device.

### SUMMARY

Accordingly, an apparatus includes at least one processor assembly configured to, for each one of at least some macroblocks of at least one computer graphics texture, compute plural endpoint colors, a mean of the endpoint colors, and a difference between the endpoint colors. The mean and the difference establish a projection vector in color-space. The processor assembly is configured to compress the mean and the difference, compute per-pixel distances along the projection vector, and use the respective mean, difference, and per-pixel distances of each macroblock to represent the macroblock.

In some examples, the processor assembly can be configured to store the respective mean, difference, and per-pixel distances of each macroblock. In other examples the processor assembly can be configured to transmit the respective mean, difference, and per-pixel distances of each macroblock to at least one receiver such that the receiver and decode the respective mean, difference, and per-pixel distances of each macroblock for presentation of the texture on a video display. The apparatus may include the receiver.

In example implementations the processor assembly can be configured to pair first and second 4×8 or 8×4 macroblocks and process the first and second macroblocks as an 8×8 macroblock. In example embodiments the processor assembly can be configured to, first time a macroblock is identified, generate a byte code representing a size of the macroblock. The macroblocks can be written as a compressed byte stream of macroblock sizes.

If desired, the processor assembly can be configured to initially split the computer graphics texture into plural tiles and for each tile, split the tile into the macroblocks.

In another aspect, an apparatus includes at least one processor assembly configured to, for each one of at least some macroblocks of at least one computer graphics texture, compute plural endpoint colors. The processor assembly is configured to represent the endpoint colors as an expression (RGBA₀+RGBA₁)/2 and (signBit(RGBA₁−RGBA₀)<<7)|round (127*normalize (RGBA₁−RGBA₀)). The processor assembly is configured to, for at least portions of a first macroblock, apply forward Discrete Cosine Transform (DCT) to the expression, and use a respective result of applying forward DCT to the respective portions to represent the respective portions. If desired, the processor assembly is configured to quantize a result of applying the forward DCT.

The processor assembly may be configured to store the respective results and/or to transmit the respective results to at least one receiver such that the receiver and decode the respective results for presentation of the texture on a video display. The apparatus may include the receiver.

In embodiments, the processor assembly may be configured to, responsive to a first portion of the first macroblock satisfying a size, apply an inverse DCT to lowest DCT coefficients of the first portion, and store results of applying the inverse DCT as a representation of the first portion. The processor assembly may be configured to, responsive to a first portion of the first macroblock satisfying a size, apply an inverse DCT to lowest DCT coefficients of the first portion and compress the results of applying the inverse DCT.

In some examples the processor assembly can be configured to order coefficients resulting from applying forward DCT to the respective portions in zig-zag order from left to right, top to bottom relative to the respective portions.

In example implementations the processor assembly can be configured to initially split at least some macroblocks into plural subblocks to establish the respective portions.

In another aspect, a method includes, for each one of at least some macroblocks of at least one computer graphics texture, computing plural endpoint colors. The method also includes executing one or both techniques on macroblocks. The first technique includes, for at least portions of a first macroblock, applying forward Discrete Cosine Transform (DCT), and using a respective result of applying forward DCT to the respective portions to represent the respective portions. The second technique includes computing a mean of the endpoint colors, and a difference between the endpoint colors, with the mean and the difference establishing a projection vector in color-space, then compressing the mean and the difference, computing per-pixel distances along the projection vector, and using the respective mean, difference, and per-pixel distances of each macroblock to represent the macroblock.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIG. 2 illustrates a first example compression technique in example flow chart format;

FIG. 3 illustrates one 256×256 tile of a texture being split into macroblocks;

FIG. 4 illustrates a second example compression technique that builds on the first in example flow chart format;

FIGS. 5 and 6 illustrate a difficult to compress macroblock being encoded in BC7;

FIG. 7 illustrates ordering forward DCT coefficients attendant to the second technique of FIG. 4; and

FIG. 8 illustrates ordering inverse DCT coefficients attendant to the second technique of FIG. 4.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor assembly may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

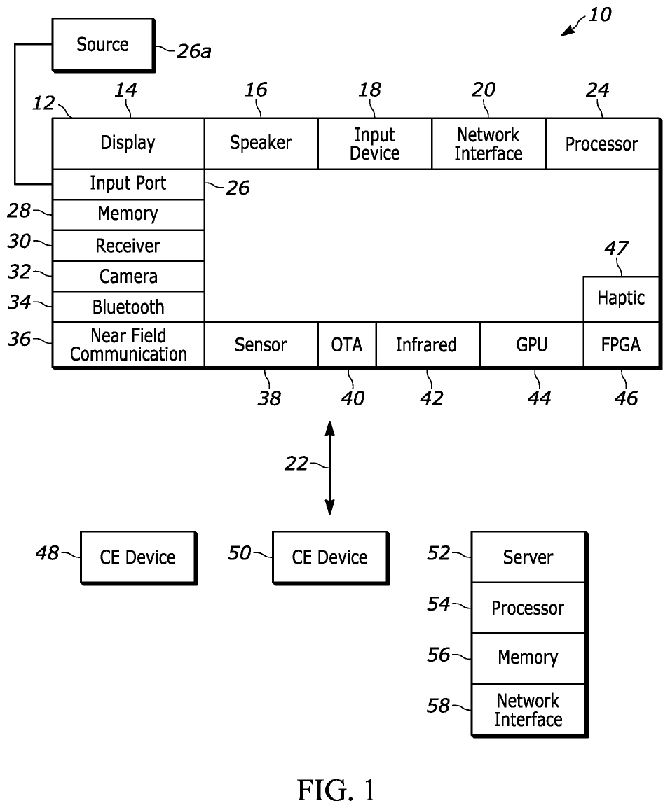

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

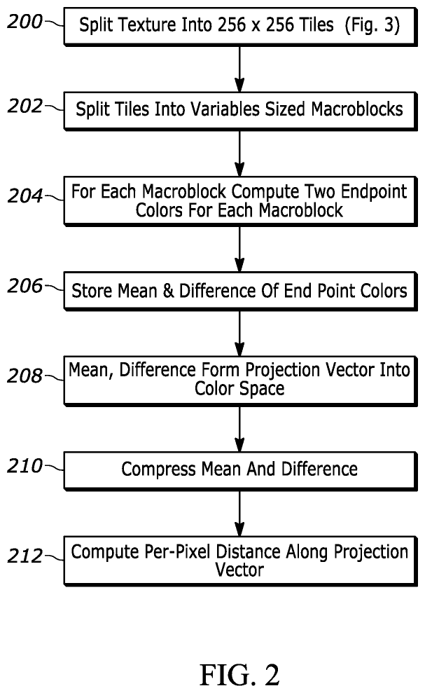

Prior to turning to FIG. 2, “textures” are data structures that can be mapped onto images to characterize the surfaces of the rendered objects. The basic data element of a texture data structure is a texture element or texel (combination of texture and pixel). Textures are represented by arrays of texels representing the texture space. The texels are mapped to pixels in an image to be rendered to define the rendered surface of the image.

Various types of compression may be used on textures. One type is block compression, sometimes expressed as BCn compression that is a lossy texture compression which can be decompressed in-place by graphics processing units (GPUs). Block compression does not require the whole image to be decompressed, so the GPU can decompress the data structure while sampling the texture as though it was not compressed at all. A particular type of block compression is BC7 in which textures are subdivided into fixed size 4×4 blocks, and each block is compressed to a fixed number of bits (e.g., BC7 uses 128 bits per block). Ignoring partitions for now, pixels in a block are represented by a single pair of endpoint colors, shared between all pixels in the block and a 16 per-pixel interpolation index values, which define how much to blend between the two endpoint colors. A pixel's color in the compressed block is calculated by blending between the two endpoint colors by the amount specified by the pixel's interpolation index.

Commencing at state 200 in FIG. 2, a texture is split into 256×256 tiles. The tiles are processed independently in the logic below.

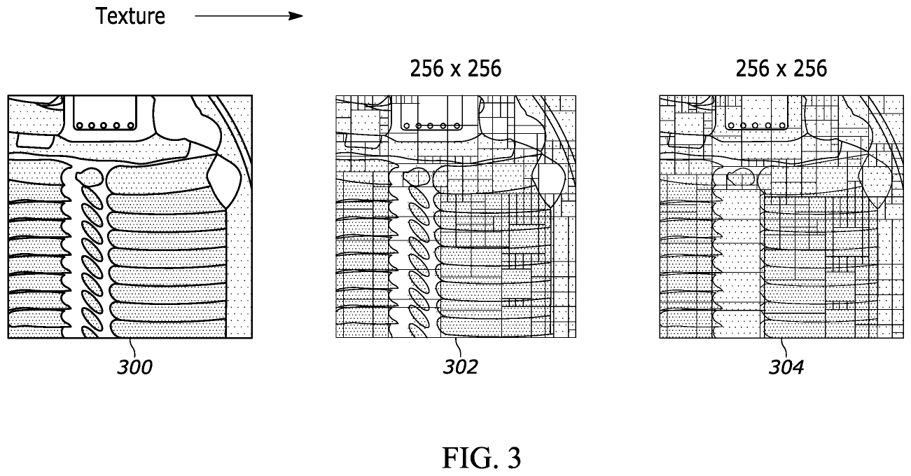

Moving to state 202, each tile such as the tile 300 shown in FIG. 3 is split into variable sized macroblocks, e.g., macroblocks with sizes of 4×8, 8×4, 8×8, 16×8, 8×16, 16×16, . . . , 64×64. The sizes are chosen to be as large as possible, while keeping error below a certain threshold. Note that 4×8 blocks may be paired and treated as a type of 8×8 block; the same is true for 8×4 blocks. In a specific example, a tile may be scanned through from left-to-right, top-to-bottom. If desired, the first time a macroblock is visited, a byte code representing its size can be written. Byte codes written for this example include 8×8, 16×16, 8×8, 8×16, 8×8, 8×8, 16×16, 16×8. Thus, the macroblocks may be written as a compressed byte stream of macroblock sizes, e.g., by using a lossless compression algorithm such as LZ.

From state 202 the logic proceeds to state 204 where, for each macroblock, two optimal 8-bit endpoint colors RGBA0 and RGBA1 are computed, while at state 206 the mean and difference of the endpoint values are computed and stored as (RGBA₀+RGBA₁)/2 and (signBit(RGBA₁−RGBA₀)*128)+round (127*normalize (abs (RGBA₁−RGBA₀))) respectively, where:

```
int4 signBit(int4 rgba) {
  int4 s;
  if (rgba.r < 0) s.r = 1; else s.r = 0;
  if (rgba.g < 0) s.g = 1; else s.g = 0;
  if (rgba.b < 0) s.b = 1; else s.b = 0;
  if (rgba.a < 0) s.a = 1; else s.a = 0;
  return s;
}
int4 abs(int4 rgba) {
  if (rgba.r < 0) rgba.r = −rgba.r;
  if (rgba.g < 0) rgba.g = −rgba.g;
  if (rgba.b < 0) rgba.b = −rgba.b;
  if (rgba.a < 0) rgba.a = −rgba.a;
  return rgba;
}
float4 normalize(int4 rgba) {
  float len = sqrt(rgba.r*rgba.r + rgba.g*rgba.g + rgba.b*rgba.b +
  rgba.a*rgba);
  float4 normalized = rgba;
  normalized.r /= len;
  normalized.g /= len;
  normalized.b /= len;
  normalized.a /= len;
  return normalized;
}
```

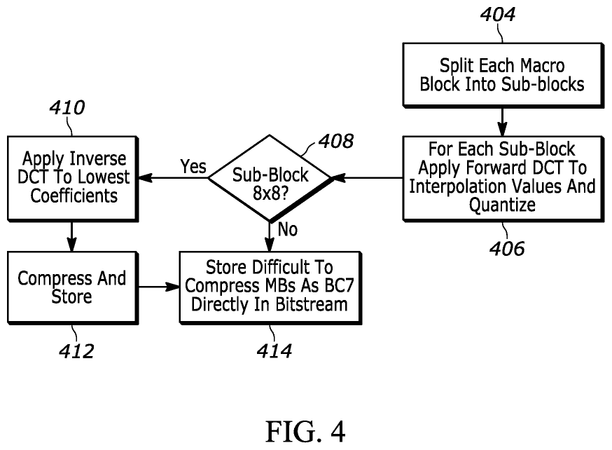

State 208 indicates that the mean and difference form a projection vector in color-space. The mean and difference are compressed at state 210 and per-pixel distances computed along the projection vector at state 212. This is illustrated in FIG. 3, where 302 shows example macroblock mean colors and 304 shows example distances along the projection vector. FIG. 4 illustrates a technique for compressing the distances along the projection vector generated by state 212 in FIG. 2. Commencing at state 404 in FIG. 4, the macroblocks for each 256×256 tile that were generated by state 202 in FIG. 2 are optionally split into smaller subblocks, the potential size of which may be the same as larger macroblocks: 4×8, 8×4, 8×8, 16×8, 8×16, . . . , 64×64, suitable for discreet cosine transform (DCT). The subblock sizes are chosen to minimize the entropy of the DCT coefficients. Subblock sizes may be written and compressed in the same way as the macroblock sizes.

From state 404 the logic proceeds to state 406 to, for each subblock, apply forward Discrete Cosine Transform (DCT) to the distances along the projection vector computed in State 212 of FIG. 2 and then quantize the result.

State 408 indicates that if a DCT subblock is larger than a predetermined size, e.g., 8×8, the logic may move to state 410 to apply an inverse DCT to the lowest (width/8)×(height/8) DCT coefficients. The results are compressed and stored at state 412.

For entropy code coefficients, a standard JPEG approach may be used or binary arithmetic coding or asymmetric numeral systems.

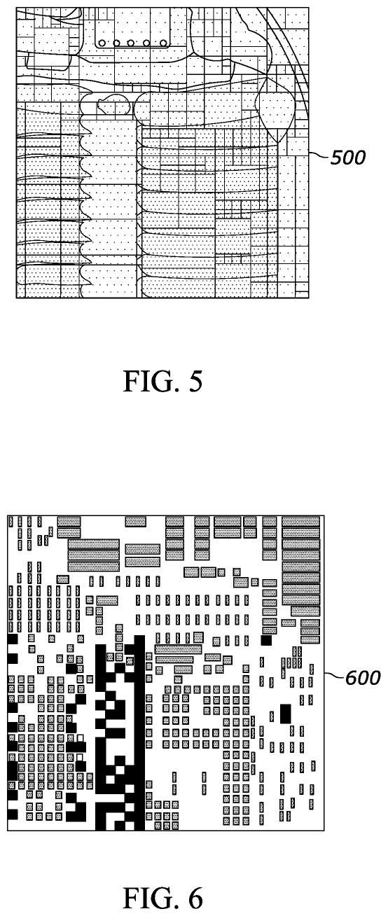

If the test at decision state 408 is negative or from state 412 the logic moves to state 414 to store difficult to compress macroblocks such as the macroblock 500 shown in FIG. 5 in BC7 format 600 as shown in FIG. 6 directly in the bitstream.

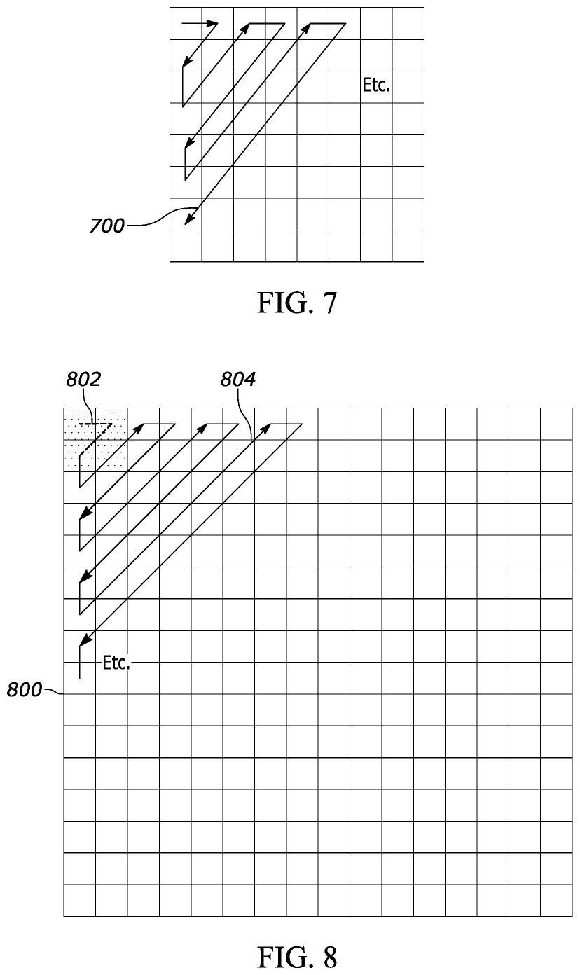

With respect to details of the DCT coefficients set forth above, forward DCT is applied to subblocks at state 406 as described above and the resulting coefficients quantized. As shown in FIG. 7, the coefficients can be ordered in zig-zag order, e.g. for an 8×8 subblock, starting with the upper left coefficient, proceeding to the next coefficient in the top row, then down to the second coefficient in the first column, then down to the third coefficient in the first column, then up to the third coefficient in the top row, then to the fourth coefficient in the top row, then down to the fourth coefficient in the first column, down to the fifth coefficient in the first column, and so on as indicated by the zig-zag line 700 in FIG. 7, with interior coefficients on the line 700 being ordered by their place on the line.

FIG. 8 illustrates how the inverse coefficients for the operation at state 410 in FIG. 4 may be ordered for a subblock of size (W×H). As discussed above, an inverse DCT is applied to the lowest (W/8×H/8) frequency DCT coefficients. For example, for the 16×16 subblock 800 shown in FIG. 8, an inverse DCT is applied to the 2×2 coefficients 802 in the square pattern in the upper left corner of the subblock 800. These transformed low frequency values may be compressed, e.g., using LZ. The (W/8×H/8) coefficients 802 may be skipped when entropy coding the remaining coefficients. The pattern of inverse DCT coefficient application may proceed in the same zig-zag fashion as disclosed above for FIG. 7, as indicated by the zig-zag line 804 in FIG. 8.

The above compressed representations of textures may be stored and/or transmitted to a receiver that may be implemented by any device for example shown in FIG. 1 to reverse the relevant encodings in a decoding process and display the texture in a computer simulation such as a computer game.

While particular techniques are herein shown and described in detail, it is to be understood that the subject matter which is encompassed by the present application is limited only by the claims.

What is claimed is:

1. An apparatus comprising:
at least one processor assembly configured to:
for each one of at least some macroblocks of at least one computer graphics texture, compute plural endpoint colors, a mean of the endpoint colors, and a difference between the endpoint colors, the mean and the difference establishing a projection vector in color-space;
compress the mean and the difference;
compute per-pixel distances along the projection vector; and
use the respective mean, difference, and per-pixel distances of each macroblock to represent the macroblock.

2. The apparatus of claim 1, wherein the processor assembly is configured to store the respective mean, difference, and per-pixel distances of each macroblock.

3. The apparatus of claim 1, wherein the processor assembly is configured to transmit the respective mean, difference, and per-pixel distances of each macroblock to at least one receiver such that the receiver can decode the respective mean, difference, and per-pixel distances of each macroblock for presentation of the texture on a video display.

4. The apparatus of claim 3, comprising the receiver.

5. The apparatus of claim 1, wherein the processor assembly is configured to:
pair first and second 4×8 macroblocks and process the first and second macroblocks as an 8×8 macroblock.

6. The apparatus of claim 1, wherein the processor assembly is configured to:
first time a macroblock is identified, generate a byte code representing a size of the macroblock.

7. The apparatus of claim 6, wherein the processor assembly is configured to:
write the macroblocks as a compressed byte stream of macroblock sizes.

8. The apparatus of claim 1, wherein the processor assembly is configured to:
split the computer graphics texture into plural tiles; and
for each tile, split the tile into the macroblocks.

9. An apparatus comprising:
at least one processor assembly configured to:
for each one of at least some macroblocks of at least one computer graphics texture, compute plural endpoint colors;
represent the endpoint colors as an expression (RGBA₀+RGBA₁)/2 and (signBit(RGBA₁−RGBA₀)<<7)|round (127*normalize (RGBA₁−RGBA₀));
for at least portions of a first macroblock, apply forward Discrete Cosine Transform (DCT) to the expression; and
use a respective result of applying forward DCT to the respective portions to represent the respective portions.

10. The apparatus of claim 9, wherein the processor assembly is configured to store the respective results.

11. The apparatus of claim 9, wherein the processor assembly is configured to transmit the respective results to at least one receiver such that the receiver can decode the respective results for presentation of the texture on a video display.

12. The apparatus of claim 11, comprising the receiver.

13. The apparatus of claim 9, wherein the processor assembly is configured to:
responsive to a first portion of the first macroblock satisfying a size, apply an inverse DCT to lowest DCT coefficients of the first portion; and
store results of applying the inverse DCT as a representation of the first portion.

14. The apparatus of claim 13, wherein the processor assembly is configured to:
responsive to a first portion of the first macroblock satisfying a size, apply an inverse DCT to lowest DCT coefficients of the first portion; and
compress the results of applying the inverse DCT.

15. The apparatus of claim 9, wherein the processor assembly is configured to:
order coefficients resulting from applying forward DCT to the respective portions in zig-zag order from left to right, top to bottom relative to the respective portions.

16. The apparatus of claim 9, wherein the processor assembly is configured to:
split at least some macroblocks into plural subblocks to establish the respective portions.

17. The apparatus of claim 9, wherein the processor assembly is configured to:
quantize a result of applying the forward DCT.

18. A method comprising:
for each one of at least some macroblocks of at least one computer graphics texture, computing plural endpoint colors;
executing at least A and/or B on the macroblocks, wherein A comprises:
for at least portions of a first macroblock, applying forward Discrete Cosine Transform (DCT), and using a respective result of applying forward DCT to the respective portions to represent the respective portions;
wherein B comprises:
computing a mean of the endpoint colors, and a difference between the endpoint colors, the mean and the difference establishing a projection vector in color-space, compressing the mean and the difference, computing per-pixel distances along the projection vector, and using the respective mean, difference, and per-pixel distances of each macroblock to represent the macroblock.

19. The method of claim 18, comprising executing A.

20. The method of claim 18, comprising executing B.
